(19) United States
(12) Patent Application Publication
(10) Pub. No.: US 2007/0163451 A1
(43) Pub. Date: Jul. 19, 2007

(54) Device for separating objects

(76) Inventor: Jean Fachaux, Saint-Martin D'Auxigny (FR)

Correspondence Address: LOWE HAUPTMAN BERNER, LLP, 1700 DIAGONAL ROAD, SUITE 300, ALEXANDRIA, VA, 22314, US

(21) Appl. No.: 11/568,210

(22) PCT Filed: Apr. 8, 2005
(86) PCT No.: PCT/FR05/00856

§ 371 Date: Nov. 7, 2006

(30) Foreign Application Priority Data
Apr. 23, 2004 (FR) 04 04354

(51) Int. Cl. A23N 4/04; A47J 17/00

(52) U.S. Cl. 99/537

(57) ABSTRACT

Objects, particularly cherries, that are initially connected together, are separated by introducing the objects into a pipe while a water vortex is turning about the center of the pipe.

### RELATED APPLICATIONS

The present application is based on, and claims priority from, France Application Number 04 04354 and PCT/FR2005/000856, filed Apr. 23, 2004 and Apr. 8, 2005, the disclosures of which are hereby incorporated by reference herein in their entirety.

### FIELD OF THE INVENTION

The invention concerns a device for separating objects initially connected together. The invention also concerns a method of separating objects initially connected together by using such a device.

It defines an application in the field of fruits processing, in particular in the separation of cherries in bunches.

### BACKGROUND OF THE INVENTION

The patent application FR-A-2 820 287 describes a device for separating cherries in bunches at their junction point. This device comprises a tank filled with water into which the cherries to be separated are poured. A first pipe is placed at the base of the tank and connects the tank to the inlet of a centrifugal hydraulic impeller pump, and a second pipe placed at the discharge from the pump redirects the cherries and water to a reception grille. The cherries are separated by virtue of a hydraulic stirring that is created inside the pump.

Hydraulic stirring is not entirely satisfactory, particularly when the cherries are strongly connected to one another.

The patent U.S. Pat. No. 1,393,287 describes a separation device for grapes in bunches comprising a pipe in which a rapid circular movement is generated. This movement is generated in an air flow and because air is a compressible medium the fruits come into contact with the walls of the pipe at the risk of being impacted, and spoilt. The use of this device is therefore not possible for fruits that must not be impacted, otherwise their appearance would be degraded.

One object of the present invention is to propose a device for separating objects initially connected together that does not have the drawbacks of the prior art.

### SUMMARY OF THE INVENTION

To this end, there is proposed a device for separating objects initially connected together, characterised in that it comprises means of generating at least one vortex of water in at least one pipe and means of introducing the said objects into the said pipe.

This embodiment is particularly advantageous since it allows an easier separation of the objects initially connected together by virtue of the fact that the vortices create centrifugal forces that tend to separate the objects without the fruits being able to be spoilt against the walls of the pipe.

Advantageously the device comprises a tank and two pipes, each being connected by introduction means to the tank, the generation means also being able to generate at least one vortex of water in each pipe.

The fitting of two pipes in a tank helps to stabilise the contents of the tank when the vortex is generated in the pipe.

According to a first embodiment, the generation means and the introduction means are disposed at one of the ends of the pipe, and the vortex generated is adapted to expel the objects towards the second end of the pipe.

According to a second embodiment, the generation means are disposed at a first end of a pipe and the introduction means are disposed at a second end of the pipe, and the vortex generated is able to suck the objects towards the first end of the pipe.

Advantageously the generation means comprise at least one pump.

The pump may be a single-channel or multi-channel impeller pump or a vortex pump.

The axis of the vortex is substantially merged with the axis of the pipe to allow the movement of the objects in the pipe without their striking the walls of the pipe.

Advantageously, the internal surface of the pipe is smooth.

Advantageously, the diameter of the pipe is at least greater than a maximum distance separating two objects when these objects are still connected together.

This characteristic prevents the objects still connected together from striking the wall of the pipe when set in rotation by the vortex.

The invention also proposes a method of separating objects initially connected together, the method comprising:
a step of generating a water vortex in a pipe; and
a step of introducing the said objects into the said pipe so they are separated by the water vortex.

Such a method allows separation of the objects initially connected together by virtue of the centrifugal forces created by the vortices.

The characteristics of the invention mentioned above, as well as others, will emerge more clearly from a reading of the following description of an example embodiment, the said description being given in relation to the accompanying drawings.

### BRIEF DESCRIPTION OF THE DRAWING

FIG. 1 is a schematic view of a device for separating cherries in bunches according to the invention;

FIG. 2 is an enlarged drawing along the section II-II in FIG. 1.

### DETAILED DESCRIPTION OF THE DRAWING

The following description will be given using a device for separating cherries in bunches but can apply to the separation of any set of objects initially connected together.

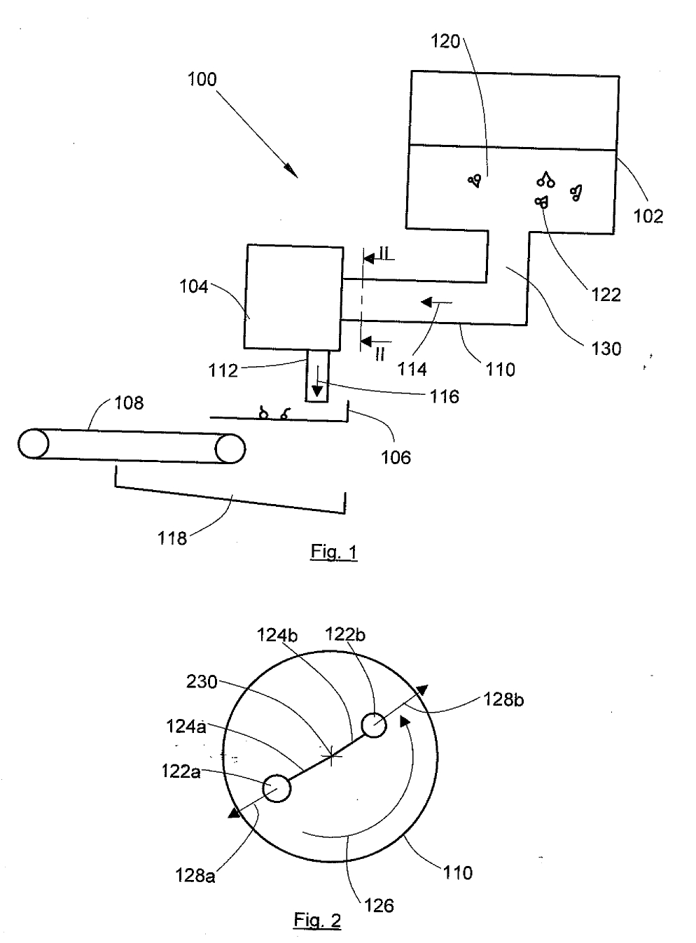

FIG. 1 is a drawing of a device 100 for separating cherries in bunches 122 that comprises a tank 102, means 104 generating at least one vortex and a reception plate 106. The generation means 104 are connected firstly to the tank 102 by a first pipe 110 and secondly to the reception plate 106 by a second pipe 112. More precisely, the first pipe 110 is connected by introduction means 130 to the tank 102 and to the inlet of the generation means 104, whilst the second pipe 112 connects the outlet of the generation means 104 to the reception plate 106. The introduction means 130 here consist of the siphon of the tank 102, but they can consist of an orifice produced in the tank 102 that is in direct engagement with the pipe 110.

The tank 102 is filled with a neutral fluid 120 that does not act on the cherries, such as for example water, and serves as a storage area for the cherries in bunches 122 that are deposited in the neutral fluid 120. When the vortex generation means 104 is activated, the neutral fluid 120 and the cherries in bunches 122 are introduced into the first pipe 110 through the introduction means 130 and are driven in the direction of the arrow 114 as far as the generation means 104 and are then expelled through the second pipe 112 in the direction of the arrow 116 as far as the reception plate 106. The quantity of neutral fluid 120 inside the tank 102 must be sufficient to prevent the tank 102 emptying when the vortex generator 104 is activated.

When the neutral fluid 120 is water, the cherries in bunches 122 do not strike the walls of the pipe 110, thus preventing the cherries from being spoiled. This is because water is a non-compressible fluid that generates a limit layer in the vicinity of the walls of the pipe 110 and this limit layer prevents the cherries from coming into contact with the walls of the pipe 110. The fruits and in particular cherries in bunches 122 therefore do not come into contact with the walls of the pipe 110, unlike what is described in the prior art, thus preventing their being impacted and spoiled against the walls of the pipe 110.

The neutral fluid 120 that is expelled onto the reception plate 106 flows in the chute 118. The neutral fluid 120 can then be returned to the tank 102 for example by virtue of a related pumping device, thus allowing closed-circuit functioning that saves on the neutral fluid 120.

The separated cherries that are expelled onto the reception plate 106 are then driven by a belt conveyer 108 that directs them to other processing steps, such as for example calibration and packaging.

The chute 118 can thus serve to redirect to the tank 102 any cherries that fall from the conveyor 108.

The generation means 104 can consist of any type of vortex generator, such as for example a hydraulic pump, and comprise a motor rotating a wheel that generates, inside the first pipe 110, a vortex whose rotation axis is substantially merged with the axis of the first pipe 110 in order to prevent the cherries from striking the wall of the pipe 110. The wheel that generates the vortex may be of the single- or multi-channel or vortex type or any other type adapted to generate a vortex in the first pipe 110.

The neutral fluid 120 is then sucked in the form of a vortex inside the first pipe 110, and the cherries in bunches 122 then undergoing centrifugal forces that tend to separate the cherries in bunches 122 from one another.

FIG. 2 is an illustration of a bunch of two cherries 122a, 122b connected by the peduncles 124a, 124b at a junction point 230. When the cherries in bunches 122a, 122b enter the first pipe 110, the vortex, represented by the arrow 126, makes the cherries in bunches 122a, 122b turn substantially about the central axis of the pipe 110. The cherries 122a, 122b are then subjected to opposing centrifugal forces 128a, 128b that tend to separate the cherries 122a, 122b from each other at the junction point 230.

The use of a vortex to separate the cherries 122a, 122b improves the cherry separation step: on the one hand, no cutting part that might damage the cherries is used and on the other hand the centrifugal forces 128a, 128b exert forces whose forces are all the greater since they are located at the junction point 230, thus allowing easier separation of the cherries 122a, 122b connected together.

To prevent the cherries 122a, 122b from striking the walls of the first pipe 110, the diameter thereof is sufficient to allow passage of cherries in bunches when they are deployed, that is to say when the centrifugal forces 128a, 128b act on the cherries in bunches 122a, 122b before their separation and tend to move them away from each other. The diameter of the pipe 110 is then at least greater than a maximum distance that separates two cherries 122 when these cherries are still connected together. However, the diameter of the first pipe 110 must not be too great so that the vortex can be generated. This is because, if the diameter is too great, the mass of neutral fluid 120 to be set in movement will be all the greater, the vortex generator 124 will then have to be sized accordingly and the speed of rotation will be greater, at the risk of spoiling the cherries when they pass into the vortex generator 104.

The minimum diameter of the first pipe 110 can be around 60 mm.

The length of the first pipe 110 must be sufficient to allow the generation of a vortex, and in fact if the pipe is too short the vortex will not have the time to form or the cherries in bunches 122a, 122b will not be subjected to the centrifugal forces 128a, 128b for sufficiently long to allow their separation. However, as with the diameter, the length of the first pipe 110 must not be too great in order to prevent the mass of neutral fluid 120 to be set in movement from being too great.

The length of the first pipe 110 can be around 1 m.

The inside of the first pipe 110 will advantageously be smooth and without roughness in order to prevent the cherries being spoilt during impacts against the wall of the first pipe 110.

The method of separating cherries in bunches 122 previously routed in this example in a tank 102 comprises:
a step of generating a vortex in the first pipe 110 filled with a neutral fluid 120 by the generation means 104, and
a step of introducing into the pipe 110 cherries 122 contained in the tank 102, which is in this example achieved by suction in the siphon 130.

The introduction of the cherries 122 into the vortex allows separation of the cherries by the effect of a centrifugal force applied to the said cherries by the vortex.

The cherries are then ejected by a second pipe 112.

The vortex generation means 104 is placed between the first pipe 110 and the second pipe 112, and the vortex is then created by the suction of the neutral fluid 120 filling the first pipe 110, as is depicted in FIG. 1.

In other words, in the embodiment depicted here, the vortex generation means 104 is disposed at a first end of the first pipe 110 and the introduction means 130 is disposed at a second end of the first pipe 110, and the vortex generated then sucks the cherries 122 towards the first end of the pipe 110.

Naturally the present invention is not limited to the examples and embodiments described and depicted but is capable of many variants accessible to persons skilled in the art.

In another embodiment of the invention, not shown in the figures, the tank 102 does not exist and the pipe 110 is then directly supplied with objects 122 to be separated through an orifice produced in the pipe 110 and which serves as an introduction means 130.

In another embodiment of the invention, not shown in the figures, the generation means 104 is, for example, placed between the tank 102 and the first pipe 110, the vortex then being created by the expulsion of neutral fluid 120 filling the first pipe 110. The generation means 104 will then no longer be situated between the first pipe 110 and the second pipe 112 but at the junction between the tank 102 and the first pipe 110.

When such generation means 104 is activated, the neutral fluid 120 and the cherries in bunches 122 are sucked out of the tank 102 into the generation means 104, and then expelled from the first pipe 110 in the direction of the arrow 114 as far as the second pipe 112, intended to route the separated cherries as far as the reception plate 106.

In other words, the generation means 104 and the introduction means 130 will then be disposed at one of the ends of the first pipe 110, the vortex being intended to expel the cherries 122 towards the second end of the pipe 110.

In operation, when the vortex is generated inside the pipe 110, the tank 102 empties into the pipe 110 through the siphon 130, which generates a vortex inside the tank 102. This vortex can create inside the tank 102 eddies liable to spoil the cherries. Fitting another siphon, in the form of another pipe 110 intended also to be the origin of a vortex generated by the generation means 104, will help to stabilise the neutral fluid in the tank 102 and thus prevent the cherries from being spoiled.

To this end, the generation means 104 can include two twin pumps each connected by means of a pipe 110 to the tank 102.

In general terms, a plurality of pipes 110 can be fitted at the tank 102, and each of these pipes is then the origin of a vortex generated by a plurality of pumps.

The tank 102 can also be provided with a plurality of siphons 130 that are joined in order to be connected to a pipe 110 that is the origin of a vortex generated by generation means 104.

1. Device for separating objects initially connected together, comprising means for generating at least one water vortex in at least one pipe, and means for introducing the objects into the said pipe while the water vortex is generated in the pipe.

2. Device according to claim 1, further including a tank and two pipes, each being connected by introduction means for introducing the objects into the pipe to the tank and in that the generation means are able to generate at least one water vortex in each pipe.

3. Device according to claims 1, wherein the means for generating and the means for introducing are disposed at one of the ends of the pipe, the pipe and the vortex being arranged to expel the objects towards a second end of the pipe opposite from the one end of the pipe.

4. Device according to claims 1, wherein generating means is disposed at a first end of a pipe and the means for introducing is disposed at a second end of the pipe, the pipe and the generated vortex being arranged to suck the objects towards the first end of the pipe.

5. Device according claim 1, wherein the means for generating comprises at least one pump.

6. Device according to claim 5, wherein the pump is a single-channel or multi-channel impeller pump or a vortex pump.

7. Separation device according to claims 1, wherein the pipe and the means for generating are arranged so the vortex has an axis that is substantially merged with the pipe longitudinal axis.

8. Separation device according to claim 1, wherein the pipe has a smooth internal surface.

9. Separation device according to claim 1, wherein the pipe has a diameter that is at least greater than the maximum distance separating two of the objects that are still connected together.

10. Method of separating objects initially connected together, comprising:
generating a water vortex in a pipe; and
introducing the objects into the said pipe while the water vortex is in the pipe.

11. The method of claim 10 wherein the water vortex turns substantially about a longitudinal axis of the pipe.

12. The method of claim 10 wherein the pipe diameter, size of the objects, and the distance separating the objects while the objects are initially connected together, are such that the objects are separated without contacting an interior wall of the pipe.

13. The method of claim 10 wherein the objects are cherries initially connected together by peduncles.

14. Apparatus for separating objects initially connected together comprising:
a pipe for holding a non-compressible liquid;
a vortex generator for inducing a vortex in the liquid in the pipe;
the vortex generator and the pipe being arranged for enabling the vortex to turn about a longitudinal axis of the pipe while the objects are in the liquid and being turned by the vortex;
the diameter of the pipe, the length of the pipe through which the vortex turns the objects, the distance separating the objects while the objects are initially connected together, the size of the objects and the rotation speed of the vortex about the axis being such that the objects are separated without contacting an interior wall of the pipe.

15. The apparatus of claim 14 wherein the objects are cherries initially connected together by peduncles.

16. The apparatus of claim 14 wherein the vortex generator and the pipe are arranged so the vortex is induced by the vortex generator at an end of the pipe opposite from an entry point into the pipe of the objects that are initially connected together.

17. The apparatus of claim 14 wherein the vortex generator and the pipe are arranged so the vortex is induced by the vortex generator at an end of the pipe proximate an entry point into the pipe of the objects that are initially connected together.
